(19) United States
(12) Patent Application Publication
(10) Pub. No.: US 2005/0132121 A1
(43) Pub. Date: Jun. 16, 2005

(54) Partitioned operating system tool

(75) Inventor: Timothy Charles Robinson, Swindon (GB)

Correspondence Address: DAVIDSON, DAVIDSON & KAPPEL, LLC, 485 SEVENTH AVENUE, 14TH FLOOR, NEW YORK, NY, 10018, US

(73) Assignee: Wind River Systems, Inc., Alameda, CA (US)

(21) Appl. No.: 10/736,941

(22) Filed: Dec. 16, 2003

(51) Int. Cl. G06F 12/00

(52) U.S. Cl. 711/100

(57) ABSTRACT

A system and method for displaying analysis data of a partitioned OS is provided. Event information is read from an event log, and a partition ID, task name and task state corresponding to the event information is determined. On a graphical display, a visual representation of the partition ID, task name and task state at a specific, corresponding time on a time graph is displayed. In this regard, the visual representation positioned to correlate with the partition ID.

### CROSS-REFERENCE TO RELATED APPLICATIONS

This application is related to U.S. Pat. No.5,872,909 entitled “Logic Analyzer for Software,” co-pending U.S. application Ser. No. 10/273,333 entitled A TWO-LEVEL OPERATING SYSTEM ARCHITECTURE and filed Oct. 17, 2002; and co-pending U.S. application Ser. No. 09/480,309 entitled “Protection Domains For A Computer Operating System” the entire disclosures of which are hereby incorporated by reference in their entirety.

### BACKGROUND

A computing environment comprising, for example, a CPU, memory and Input/Output (I/O) devices, typically includes an operating system to provide a way to control the allocation of the resources of the environment. Traditional multitasking operating systems (e.g., UNIX, Windows) have been implemented in computing environments to provide a way to allocate the resources of the computing environment among various user programs or applications that may be running simultaneously in the computing environment. The operating system itself comprises a number of functions (executable code) and data structures that may be used to implement the resource allocation services of the operating system.

Certain operating systems, called “real-time operating systems,” have been developed to provide a more controlled environment for the execution of application programs. Real-time operating systems are designed to be “deterministic” in their behavior—i.e., responses to events can be expected to occur within a known time of the occurrence of the event, without fail. Determinism is particularly necessary in “mission-critical” and “safety-critical” applications, where the outcome of event responses is essential to proper system function. Real-time operating systems are therefore implemented to execute as efficiently as possible with a minimum of overhead. As a result, prior real-time operating systems have typically employed relatively simplistic protection models for system and user processes—typically all processes execute in the same space, thus allowing direct access to all system resources by all user tasks (system calls can be made directly). This real time operating system model provides the fastest execution speed, but is deficient in providing system protection.

In order to improve system protection, it has been proposed to provide an operating system that is adopted to partition the computing environment. This can be achieved by implementing, for example, a “protection domain” architecture. VxWorks®AE, marketed by Wind River Systems of Alameda, California, is an example of such a protection domain system. Basically, the protection domain system segregates, or portions, the computing environment into a number of “protection domains.” Each protection domain is a “container” for system resources, executable code and data structures, as well as for executing tasks and system objects (such as semaphores and message queues). Each resource and object in the system is “owned” by exactly one protection domain. The protection domain itself is a self-contained entity, and may be isolated from other system resources and objects to prevent tasks executing in the protection domain from potentially interfering with resources and objects owned by other protection domains (and vice versa).

The protection domain system of VxWorks®AE also, however, provides mechanisms by which tasks executing in one protection domain may access resources and objects contained in a separate protection domain. Each protection domain includes a “protection view” that defines the system resources and objects to which it has access (i.e., the resources and objects which it can “see”). By default, each protection domain has a protection view that includes only the system resources and objects contained within that protection domain. However, a protection domain may acquire access to the resources of other protection domains by “attaching” to these protection domains. When a first protection domain has obtained “unprotected attachment” to a second protection domain, the second protection domain is added to the protection view of the first protection domain. Executable code in the first protection domain may use “unprotected links” to functions selected in the second protection domain, allowing tasks executing in the first protection domain to use the resources and access the objects of the second protection domain with a minimum of execution overhead.

Unrestricted access by all tasks executing in one protection domain to all the resources and objects of another protection domain may not be desirable, however, for reasons of system protection and security. The VxWorks®AE protection domain system therefore provides a further mechanism whereby individual tasks executing in a first protection domain may access resources or objects contained in a second protection domain, but without adding the second protection domain to the protection view of the first protection domain. This access is achieved by “protected attachment” of the first protection domain to the second protection domain via a “protected link” between executable code in the first protection domain and selected functions in the second protection domain. Using the protected link, a task running in the first protection domain may, for example, make a direct function call to a function existing in the second protection domain, without the need to alter the protection view of the first protection domain. Tasks in the first protection domain are prevented from accessing the second protection domain except through this protected link, thus preventing unauthorized accesses of functions and data in the second protection domain. Protected linking can be achieved without the need to use different code instructions for protected and unprotected accesses (increasing implementation flexibility), and without the need to create separate tasks in the protected protection domain to perform the desired actions.

Such a protection domain system allows the operating system to dynamically allocate system resources among processes and flexibly implements and enforces a protection scheme. This protection scheme can be formulated to control the impact of poorly written applications, erroneous or disruptive application behavior, or other malfunctioning code, on the operating system and other applications running in the computer system. The protection domain approach accomplishes the protection results in a manner that is transparent to application developers, and incurs minimal execution overhead.

There are many applications where software needs to exert real-time control. Examples include control systems for aircraft, factories, automobiles, printers, broker transaction computers, etc. A typical implementation would have a dedicated target computer which controls the aircraft, factory, etc., with target software on the target computer. This computer could be uplinked via a TCP-IP ethernet link, serial linked, networked or otherwise connected to a host system such as a host computer. This host could be a Unix®-based workstation or a Windows®-based PC, for example. The host can be used to download and configure the software which will run on the target computer, and to customize such software as well.

U.S. Pat. No.5,872,909 entitled “Logic Analyzer for Software,” (“the '909 patent”), describes a system which logs events that occur in target software and displays context status information in a time-line fashion with specific icons indicating events and status changes to show task interaction over time. The system is useful for monitoring performance of software, in particular real-time, embedded or multi-tasking software running on a target computer. The WindView® software analyzer product manufactured and distributed by Wind River Systems, Inc. is a commercially available product that has made use of this system with a host monitoring a separate target.

The system of the '909 patent logs events which occur in the target software, and stores these in a buffer for periodic uploading to the host system. Such events include context switching times of particular software tasks, and task status at such context switch times, along with events triggering such a context switch or other events. The host system reconstructs the real-time status of the target software from the limited event data uploaded to it. The status information is then displayed in a user-friendly manner. This provides the ability to perform a logic analyzer function on software in real time (or as a post-mortem). A display having multiple rows, with one for each task or interrupt level, is provided. Along a time line or an axis representing a sequence of events, an indicator shows the status of each task/interrupt with icons indicating events and any change in status. The task status may be indicated with different line patterns or stipples, for example, a wavy line indicating that a program is ready to run, a dotted line indicating that a program is waiting for a semaphore or a message from a message queue that it needs to run, and a dashed line indicating the program is waiting for a time-out. This detailed graphical interface provides an easily understood overall representation of the status of a target software.

### SUMMARY OF THE INVENTION

In accordance with one embodiment of the present invention, a system and method for displaying analysis data of a partitioned OS is provided. Event information is read from an event log, and a partition ID, task name and task state corresponding to the event information is determined. On a graphical display, a visual representation of the partition ID, task name and task state at a specific, corresponding time on a time graph is displayed. In this regard, the visual representation is positioned to correlate with the partition ID.

In accordance with another embodiment of the present invention, a system and method for monitoring the execution of a plurality of tasks in the memory of a target computer is provided. The target computer is coupled to a host program with a communications link, and a plurality of tasks are run on the target computer. Event data is produced, wherein the event data includes a partition ID. The event data is entered into a log with a time stamp, and the log is uploaded to the host. The log is parsed to retrieve the event data, the partition ID is accessed, and an event dictionary corresponding to the partition ID is loaded. A task name and task state is determined from the event dictionary, and the task name is displayed on a first axis with the partition ID. Time progression is displayed on a second axis, and a graphical icon representative of the task state is displayed at a time on the second axis corresponding to the time stamp.

In accordance with another embodiment of the present invention, a system and method for monitoring the execution of a plurality of tasks in the memory of a target computer is provided. The target computer is coupled to a host program with a communications link, and a plurality of tasks run on the target computer, producing a plurality of contexts. Event data is logged which represents a plurality of events in the plurality of contexts. The event data includes an event identifier, a partition identifier, a time stamp, and an array of parameters, which are logged in a predetermined order. The event data is uploaded from the target computer memory to the host program, and the status of the tasks is reconstructed from the event data. The reconstructed data is stored in the host program, and the status from the reconstructed data is displayed for a period of time for a plurality of the tasks with the same partition identifier on a display.

In accordance with other embodiments of the present invention, computer readable media are provided, having stored thereon, computer executable process steps operable to control a computer(s) to perform the methods described above.

### BRIEF DESCRIPTION OF THE DRAWINGS

FIG. 1 is a diagram of a target and a host computer according to a prior art arrangement.

FIG. 2 is a diagram of display graphics according to a prior art arrangement.

FIG. 3 shows an exemplary display according to an embodiment of the present invention.

FIG. 4 shows the system space of the target computer system of FIG. 1.

FIG. 5 shows the system space of FIG. 4 arranged into partitions according to an exemplary embodiment of the two-level operating system architecture according to the present invention.

FIG. 6 shows a graphical representation of a time-multiplexed partition scheduling arrangement according to the present invention.

FIG. 7 is a block diagram of a communication system for inter-partition message passing according to an exemplary embodiment of the present invention.

FIG. 8 shows the system architecture of the two-level OS monitoring system according to an embodiment of the present invention.

FIG. 9 is a flowchart for the process of event logging that occurs in the target system of FIG. 8.

### DETAILED DESCRIPTION

Conventional software logic analyzers are of limited use in analyzing protection domain systems analysis because no accommodation in the software logic analyzer is made for the separate partitions. As a result, there is no way to determine partition-specificity. In other words, the logic analyzer does not provide a way to determine what is occurring in which partition at a specific time, which partition a particular task belongs to, which partition is responsible for a certain event, and so on.

According to an embodiment of the present invention, a software logic analyzer for monitoring a protection domain system is provided that monitors individual threads in each partition in a partitioned operating system (partitioned OS).

Preferably, the partitioned OS includes a core operating system and a system space having a number of memory locations. The core operating system partitions the system space into a plurality of partitions. Each of the partitions includes a partition operating system and a partition user application. Each partition operating system provides resource allocation services to the respective partition user application within the partition. Also according to another exemplary embodiment of the present invention, the core operating system is arranged to schedule the partitions such that the partition operating system, partition user application pairs are temporally partitioned from each other. The core OS and each partition OS have a corresponding partition ID.

In accordance with one embodiment of the present invention, a system and method for displaying analysis data of a partitioned OS is provided. Event information is read from an event log, and a partition ID, task name and task state corresponding to the event information is determined. On a graphical display, a visual representation of the partition ID, task name and task state at a specific, corresponding time on a time graph is displayed. In this regard, the visual representation is positioned to correlate with the partition ID. In accordance with a further aspect of the above-embodiment, step of determining the partition ID, task name and task state further comprises loading an event dictionary corresponding to the partition ID and determining the task name and task state from the event definitions. In this regard, descriptions of the formats of event data are stored in the host in ‘event dictionaries’ for each partition. These dictionaries describe the formats of all the events which may appear in the log that's uploaded to the host. The format of event data that is emited may vary between partitions, depending on the partition operating system. In order to support differences between partitions, it is possible for the host tool to have several dictionaries in use concurrently. Each partition, and the core operating system, has a dictionary, and as events are received, the correct dictionary is selected.

In accordance with another embodiment of the present invention, a system and method for monitoring the execution of a plurality of tasks in the memory of a target computer is provided. The target computer is coupled to a host program with a communications link, and a plurality of tasks are run on the target computer. Event data is produced, wherein the event data includes a partition ID associated with a currently executing partition. The event data is entered into a log with a time stamp, and the log is uploaded to the host. The log is parsed to retrieve the event data, the partition ID is accessed, and an event dictionary corresponding to the partition ID is loaded. A task name and task state is determined from the event dictionary and event data, and the task name is displayed on a first axis with the partition ID. Time progression is displayed on a second axis, and a graphical icon representative of the task state is displayed at a time on the second axis corresponding to the time stamp. Preferably, the event data also includes event data indicative of a partition switch (e.g., a change in the currently executing partition to a second partition), and, when partition event data is produced, data including an indication of the switch to the second partition, and configuration information for the second partition. This configuration information may comprise a second partition ID, and a partition event dictionary for the second partition. Preferably, the configuration data is emitted once for each partition, when it emits its first event data. The configuration data is preferably emitted first, followed by event data. Thus when the event is encountered by the host tool, the required configuration information is already available.

In accordance with another embodiment of the present invention, a system and method for monitoring the execution of a plurality of tasks in the memory of a target computer is provided. The target computer is coupled to a host program with a communications link, and a plurality of tasks run on the target computer, producing a plurality of contexts. Event data is logged which represents a plurality of events in the plurality of contexts. The event data includes an event identifier, a partition identifier, a time stamp, and an array of parameters, which are logged in a predetermined order into a buffer. The event data in the buffer is uploaded from the target computer memory to the host program, and the status of the tasks is reconstructed from the event data. The reconstructed data is stored in the host program, and the status from the reconstructed data is displayed for a period of time for a plurality of the tasks with the same partition identifier on a display.

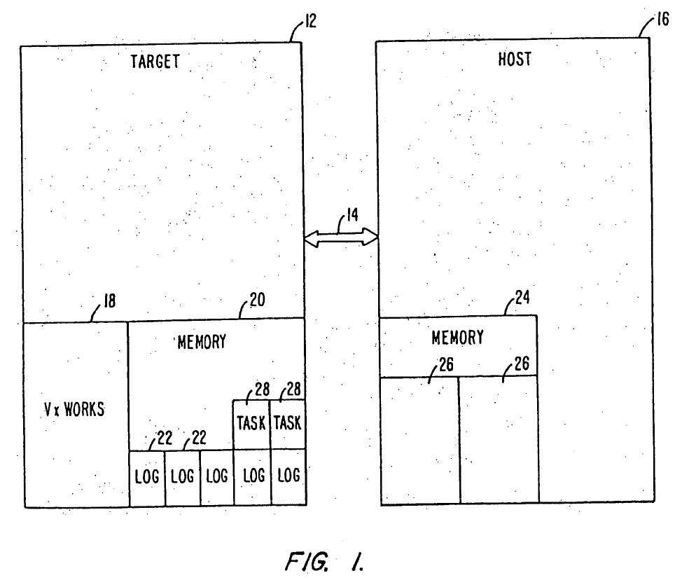

Certain preferred embodiments of the present invention will now be discussed in further detail in connection with FIGS. 1-9.

FIG. 1 illustrates a target computer 12 connected via a link 14 to a host computer 16 according to the prior art arrangement of the '909 patent. The target computer includes an operating system (OS) 18, and a memory 20 with a buffer for storing logs of events 22, which are periodically uploaded to host 16 via link 14. Host 16 includes a memory 24 with reconstructed data fields 26. Data fields 26 are reconstructed from the event log(s) 22 to provide the status of different tasks running in the OS 18. These different tasks are stored in memory 20, indicated as tasks 28, and run as needed.

Link 14 is preferably an ethernet link, using TCP-IP protocol. Alternately, link 14 can be a connection over an in-circuit or ROM emulator, a serial line or any other point-to-point communication technique. Host 16 is typically a workstation running a Unix® or Unix®-based operating system, or a PC running Windows® operating system.

The significant events 22 which are logged include switching from one task 28 to another, a change in the state of a task, or certain events which the user desires to display on a debug display. When logged, many events are time-stamped. Target computer 12 could be a separate traditional stand-alone computer, or could be an embedded computer board that is plugged into a car, printer, etc.

In addition to the target-and-host structure set forth above, aspects of the present invention are useful where a single computer runs both the target and host software. An example is a multi-tasking environment running on a workstation. The uploading bandwidth is not a constraint in this environment, but the lack of intrusiveness and the ability to provide the status and event display are very useful.

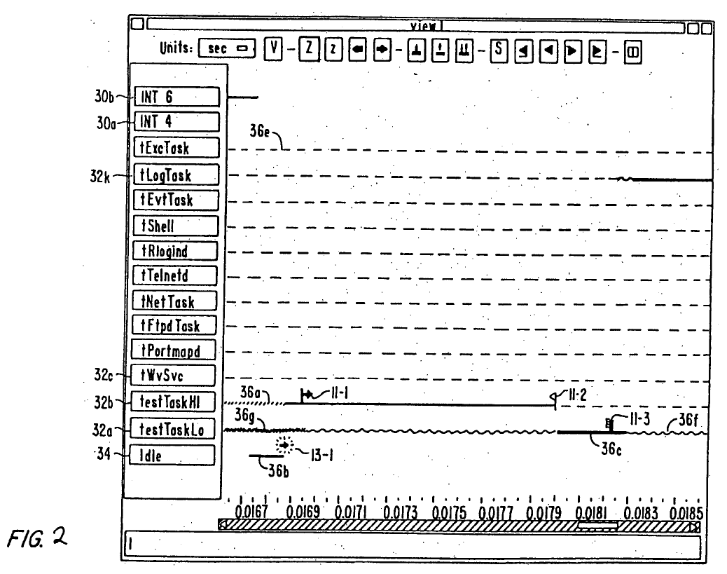

FIG. 2 shows an example of the main display according to the '909 patent. The information collected in the logs is represented graphically to show the states of a number of tasks within the system being monitored. Along a vertical axis are indicated tasks or interrupt service routines (ISRs), such as tasks 32 and ISRs 30. The horizontal axis is a time line, with information displayed along the time line for each program. The display indicates the state of each task 32 at a particular time and the execution of a particular ISR.

FIG. 2 also shows a representation of the “idle loop” 34. Not actually a task or an ISR, the idle loop is the code which the OS kernel executes when there are no tasks ready to execute and no interrupts to service. In this loop, the kernel typically services interrupts as they arise and continually checks to see if a task is ready to run. A representation of the idle loop along with the tasks and ISRs is useful in that analyzing the amount of time a system is idle can help the user fine tune the application(s). A system which spends only a small fraction of execution time in the idle loop may be near its maximum capacity, and may be unable to handle unexpected demands. Conversely, a system which spends much time in the idle loop may be over-specified. This information may help the designed to correctly specify the system.

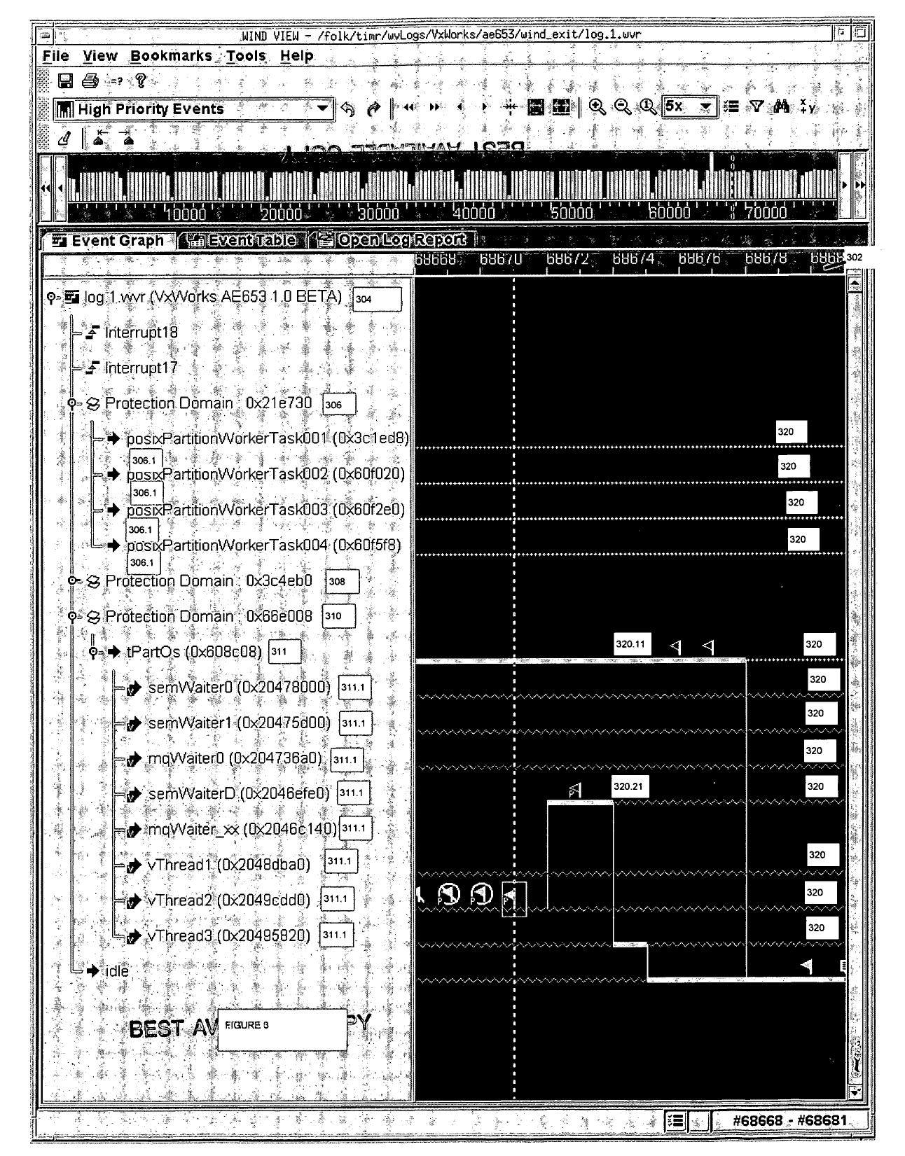

In accordance with an embodiment of the present invention the display of FIG. 2 is modified by grouping tasks into their respective partitions like the exemplary display 300 in FIG. 3. Preferably, the partitions include a core OS partition having a core operating system and at least one partition having a partition operating system as described below. The log name 304 is displayed at the top and each protection domain 306, 308 and 310 is listed with their respective memory address locations as identifiers. The first protection domain 306 (the core OS) resides at memory address location 0×21e730, the second protection domain at 0×3c4eb0, and the last at 0×66e008. Each protection domain 306, 308 and 310 is vertically aligned to be directly above one another with their respective tasks listed underneath them in an outline form. For example, the first domain 306 has its tasks 306.1 listed underneath in a list format, each task vertically aligned along an indent under the domain name 306. The second domain 308 has no tasks and the third domain 310 has a partition OS 311 (“tPartOS”) which has its respective tasks 311.1 listed underneath. A time line 302 indicates the progression of time and graphical icon lines 320 positioned next to each task indicate the state of each task at a specific time.

Each distinct line pattern represents a different task state. The relationship between a graphical representation and a task is arbitrary and the line may take any form. In this example, a dotted line, like those next to the worker tasks 306.1, indicate a pending state. The wavy, pointed lines next to the bottom domain's tasks 311.1 indicates a suspended state. The thick, solid line 320.11 next to tPartOS indicates that tPartOS is the operating partition during the point in time coinciding with the line 320.11. The solid line 320.21 indicates an executing state for the semWaiterD task, and the “flag” is a conventional Windview symbol indicating that a semaphore has been given.

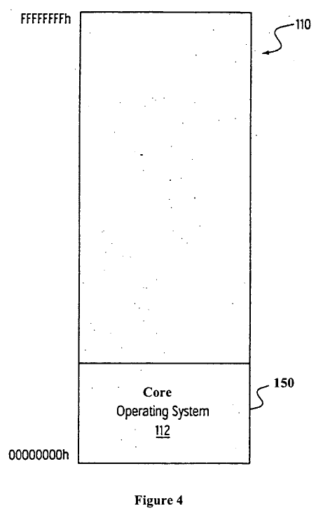

FIG. 4 illustrates an exemplary system space 110 of the target system 12 residing in its memory 20. System space 110 is, for example, an addressable virtual memory space available on the target system 12. The system space 110 maybe equal to or greater than the memory capacity of the physical memory 20 of the target 12, depending on system memory management implementations, as are well known. System space 110 may also include memory locations assigned as “memory mapped I/O” locations, allowing I/O operations through the system space 110. As shown in FIG. 4, the system space 110 includes addressable locations from 00000000h (hexadecimal) to FFFFFFFFh, defining a 32-bit addressable space. In this example, the system space 110 is implemented as a “flat” address space: each address corresponds to a unique virtual memory location for all objects in the system space 110 regardless of the object's owner. Other known addressing methods may also be used.

According to the present invention, the system space 110 stores a core operating system 112, such as, for example the VxWorksAE operating system. The core operating system 112 includes executable code and data structures, as well as a number of executing tasks and system objects that perform system control functions, as will be described in more detail below. The core operating system 112 implements a protection domain system in which all resources and objects are contained within protection domains. The core operating system itself can be contained in a protection domain 150. The exemplary protection domain system of the core operating system 112 is also object oriented, and each protection domain is a system object.

By way of background, operating systems implemented in an “object oriented” manner are designed such that when a particular function and/or data structure (defined by a “class” definition) is requested, the operating system creates (“instantiates”) an “object” that uses executable code and/or data structure definitions specified in the class definition. Such objects thus may contain executable code, data structures, or both. Objects that perform actions are typically referred to as “tasks” (also known as “threads”), and a collection of tasks may be referred to as a “process.” Upon loading and execution of an operating system into the computing environment, system tasks and processes will be created in order to support the resource allocation needs of the system. User applications likewise upon execution may cause the creation of tasks (“user tasks”), processes (“user processes”), and other objects in order to perform the actions desired from the application.

The structure of each protection domain is defined through a protection domain “class” definition. A protection domain may be created, for example, by instantiating a protection domain object based on the protection domain class. Only the core operating system 112 can create or modify (or destroy) a protection domain, although user tasks can request such actions through a protection domain application programming interface (API) provided by the core operating system. A protection domain object is owned by the protection domain that requested its creation.

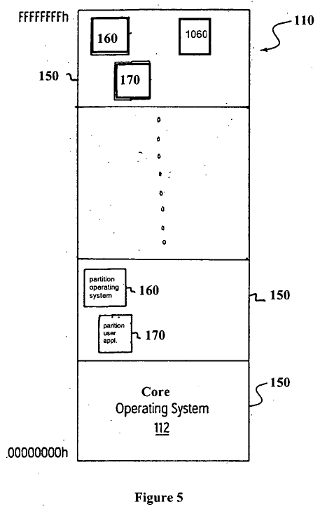

Referring now to FIG. 5, there is illustrated the system space 110 of FIG. 4 arranged into partitions according to an exemplary embodiment of a two-level operating system architecture according to the present invention. The core operating system 112 instantiates a number of protection domains 150 to provide partitions within the memory system space 110, as will be described in more detail below. Instantiated within each partition defined by a protection domain 150 is a partition operating system 160 and a partition user application 170. According to this exemplary embodiment of the present invention, each partition operating system 160 is dedicated to the respective partition user application 170 within the same protection domain 150, and the partition user application 170 interacts with the respective partition operating system 160. The partition operating system 160 allocates resources instantiated within the protection domain 150 to the respective partition user application 170. As discussed, each of the partition operating system 160 and the respective partition user application 170 of a particular protection domain-defined partition comprises objects including executable code and/or data structures. All of such objects are instantiated in the respective protection domain of the partition. The term “user application” is used herein to denote one or more user applications instantiated within a particular protection domain.

In this manner, user applications can be spatially separated into discrete partitions of the system space 110 so that they are unable to interact with each other, except through explicit mechanisms, as for example, under tight control of the two-level operating system architecture implementing the protection domain scheme. Moreover, each user application 170 can be controlled through explicit allocation of resources owned by the protection domain, by the partition operating system 160, to prevent the applications from affecting the operation of the entire system.

The core operating system 112 performs certain functions for the overall system and/or on behalf of each partition operating system 160. As discussed, the core operating system 112 creates and enforces partition boundaries by instantiation of the protection domains 150. The core operating system 112 schedules partition operation among the several protection-domain-defined partitions, to determine which user application and respective partition operating system will be operating at any given time. In addition, the core operating system 112 can control system resource allocation, the passing of messages between the partitions, the trapping of exceptions and execution of system calls, on behalf of the partition operating systems 160, and the Input/Output systems 103.

Each of the partition operating systems 160 can be implemented from object components of a real time operating system such as, for example, VxWorks, marketed by Wind River Systems of Alameda, Calif. The components can include, for example, kernel, math, stdio, libc and I/O functionality of the VxWorks real time operating system to achieve resource allocation for user task management and inter-task communication for the respective partition user application 170. Each partition operating system 160 is also implemented to support user-application level context switches within a partition, and to indirectly interact with I/O devices via calls to the core operating system 112. Each partition operating system 160 can also be configured to call the core operating system 112 for access to resources maintained at the system level, and for the handling of traps and exceptions by the core operating system 112.

In addition, during the protection domain creation process by the core operating system 112, the memory space is loaded with code modules. Pursuant to the present invention, the code modules include the partition operating system 160 of the respective partition 150, and the respective user application. The code modules comprising the partition operating system 160 and the respective partition user application 170, are therefore spatially separated from other code modules of system space 110 by a protection domain-defined partition. Thus, according to this example the present invention, execution of user tasks and processes, and resource allocation control functions of an operating system for the specific tasks and processes can be accomplished from within a protected and separated portion of the system space 110. Such an arrangement minimizes the ability of a user application form affecting anything within the system space that is beyond its partition.

For maximum security, the protection view of a partition 150 can be set in the default mode wherein only objects within the specific protection domain memory space 110 can be accessed by executable code executing within the partition 150. Thus, each partition operating system and partition user application pair can be substantially spatially isolated from all other system space.

However, the executable code may include a number of instructions, which, for example, in the case of a code module of the respective partition user application 170, reference other executable code or data structures outside of code module (e.g., via a “jump” or “branch” instruction to execute a function). These references may be made using “symbols” that are intended to represent the memory location of the desired code or data structure. In order to determine (“resolve”) the memory address value of these symbols, the loading of code modules may include a linking process of the type provided in the VxWorksAE operating system, that attempts to resolve symbol references by searching for other occurrences of the symbol either in other code modules 126 already loaded into the respective protection domain 150, or in code modules loaded into other protection domains.

The core operating system 112 schedules partition operation to determine which partition operating system, partition user application pair is to execute at any particular time. The core operating system implements temporal partitions, preferably using a time-multiplexed schedule, between the partition operating system, partition user application pairs of the protection domain-defined spatial partitions 150.

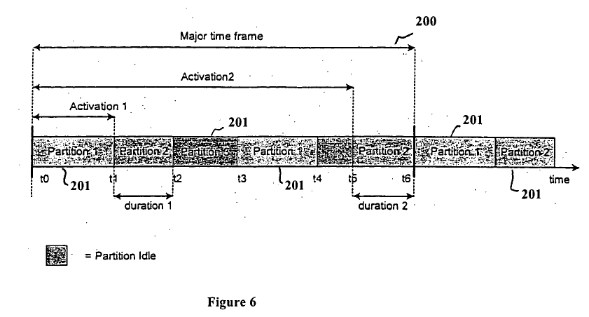

A preferred time-multiplexed schedule is illustrated in FIG. 6. A timing sequence comprises a series of major time frames 200. The major time frames 200 are repetitive, and each major time frame 200 has a predetermined, fixed periodicity. In this manner, the major time frames 200 are deterministic. The basic scheduling unit of the major time frame 200 is a temporal partition 201, and there is no priority among the temporal partitions 201.

Alternative schemes for providing temporal partitions could also be used. For example, a priority based scheme could be used wherein the partition with the highest priority task (or other operation) is scheduled for a specified duration.

Returning to the time-multiplexed schedule of FIG. 6, at least one temporal partition 201 is allocated to each protection domain-defined spatial partition 150, and a protection domain-defined partition 150 is activated by allocation of at least one temporal partition 201 from within the major time frame 200 to the particular partition 150. Each temporal partition 201 has two attributes, an activation time t0-t6, within the major time frame 200 and an expected duration (duration 1, duration 2). Each temporal partition is defined by an offset from the start of a major time frame 200 and its expected duration. The duration of each temporal partition is set in fixed increments. The value of the increments can be configurable.

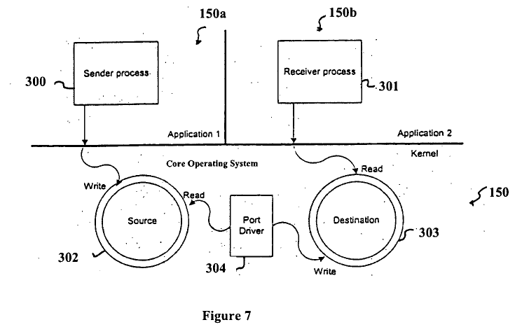

Referring now to FIG. 7, there is illustrated an exemplary communication system for passing a message between two of the partitions 150. In this example, the sending partition 150a includes a sender process 300, and the receiving partition 150b includes a receiver process 301. Moreover, each of a source port 302 for the sending partition 150a and a receiving port 303 for the receiving partition 150b comprises a circular buffer implemented in the core operating system 112. Each circular buffer is defined by a set of attributes including, for example, an identification of the partition with which it is associated, and whether it is a source port or a receiving port.

A port driver 304 is implemented in the core operating system 112, and is operable to read messages stored in each source port 302 and to write the read messages into the receiving port(s) 303 of the partition(s) identified in the message as the receiving partition(s) 150b. When the sending partition 150a needs to send a message to the receiving partition 150b, the sender process 300 formats a message, including, for example, a message descriptor to identify such information as source and destination of the message. The sender process 300 then writes the message into the corresponding source port 302 circular buffer in the core operating system 112. The sender process 300 then updates a write pointer. The port driver 304 reads each message in the source circular buffer and writes each read message into the receiving port 303 circular buffer of the receiving partition 150b identified in the message descriptor of the message. According to the exemplary embodiment, of the present invention, each receiving partition 150b periodically reads the messages stored in the corresponding circular buffer comprising the receiving port 303 of the partition 150b. A table of message descriptors can be maintained by the core operating system 112 to enable the core operating system 112 to track all messages.

Time management within a partition is accomplished through maintenance of a single timer queue. This queue is used for the management of watchdog timers, and timeouts on various operations.

Elements on the queue are advanced when a system clock “tick” is announced to the partition operating system. Each tick denotes the passage of a single unit of time. Ticks are announced to the partition operating system from the core operating system through a “pseudo-interrupt” mechanism (e.g., via a system clock tick event). During initialization of the partition operating system, the current tick count maintained by the partition operating system will be set to equal the value of the core operating system tick count (as a result, the tick count of each partition will be synchronized with each other and the core operating system). Preferably, there are no limits on the clock tick rate that can be accommodated by the partition operating system, other than the available processor cycles that can be utilized by the system in servicing clock hardware interrupts and issuing pseudo-interrupts.

Preferably, clock ticks are only delivered to a partition during that partition's window of execution (e.g., via a system clock tick event). When the core operating system schedules in a new partition, the clock ticks are then delivered to the newly scheduled partition. The issuance of clock ticks to the scheduled-out partition recommences at the start of the partition's next window. At this point, the core operating system announces, in batch mode (e.g., with a single pseudo interrupt), all the clock ticks that have transpired since the last tick announced to the partition in its previous window. In such a system, a timeout (or delay) can expire outside the partition's window, but the timeout is only acted upon at the beginning of the next partition window. It should be appreciated, however, that if a particular time out (or delay) is critical, the system integrator could simply increase the duration of temporal partition 201 for the corresponding spatial partition 150, or provide that a plurality of temporal partitions 201 be assigned to the spatial partition.

The batch delivery of clock ticks allows the core operating system to conserve processor cycles. Although the core operating system is still required to service the clock hardware interrupts, processor cycles are conserved by elimination of the overhead involved in issuing pseudo-interrupts, and the subsequent processing of the ticks within the various partition operating systems. This is particularly true for systems that require a timeout specification granularity of 0.25 milliseconds (which translates into 4000 ticks per second).

Scheduling of tasks within a partition can be implemented in a number of ways. For example, tasks within a partition may be scheduled using a priority scheme. In a preferred embodiment of the present invention, the priority scheme is implemented in accordance with a pre-emptive priority-based algorithm. In such an embodiment, each task has an assigned priority, and in each partition, the partition operating system scheduler uses the priority assigned to each task to allocate the CPU to the highest-priority task within the partition that is ready to execute.

In a pre-emption based scheme, pre-emption occurs when a task of higher priority than the currently executing task becomes ready to run. In general, a higher-priority task may become ready to run as a result of the expiration of a timeout, or the new availability of a resource that the task had been pending on. Pre-emptive events are delivered from the core operating system to the partition operating system, through the pseudo-interrupt mechanism. These events, which may result in a higher priority task becoming available, include but are not limited to, the system clock tick and the system call completed signals (discussed below).

The scheduling of equal priority tasks can be implemented in a number of ways. For example, equal priority tasks can be scheduled on a first-come-first serve basis (e.g., using a queue of equal priority tasks). Alternatively, round-robin scheduling could be used. Preferably, the system allows the system integrator to select either round-robin scheduling or first-come-first-serve scheduling. Round-robin scheduling allows the processor to be shared by all tasks of the same priority. Without round-robin scheduling, when multiple tasks of equal priority must share the processor, a single non-blocking task can usurp the processor until pre-empted by a task of higher priority, thus never giving the other equal-priority tasks a chance to run. In accordance with round-robin scheduling, a “time slice” (or interval) is defined which represents the maximum time that a task is allowed to run before relinquishing control to another task of equal priority. Preferably, the “time slice” is a variable that can be set by calling an appropriate routine.

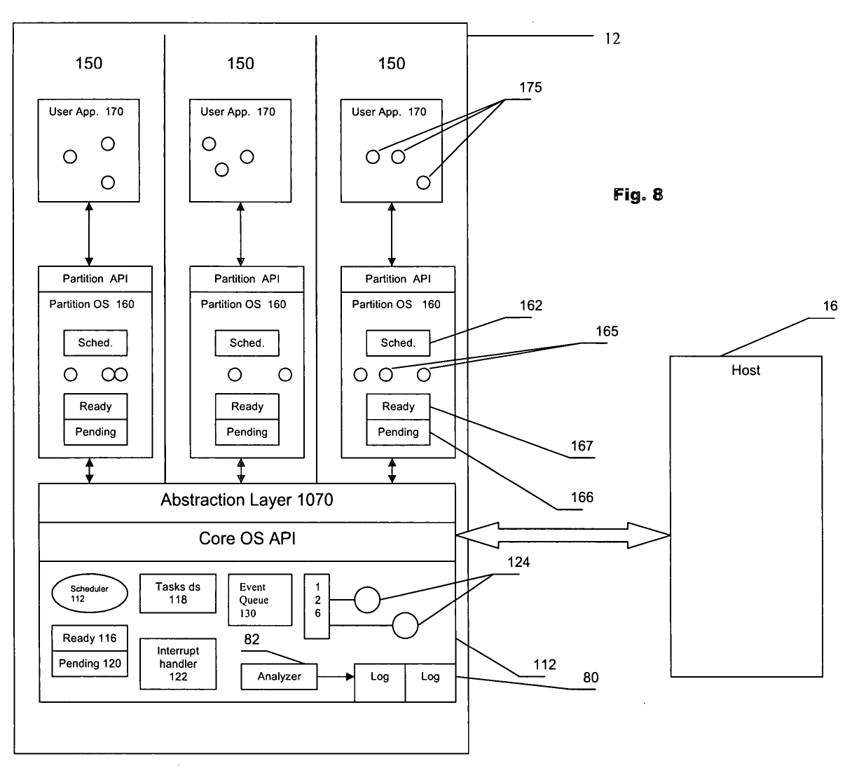

When a partition operating system 160, or an application running in a partition operating system 160, needs to request a service from the core operating system, a system call is issued from the partition operating system to the core operating system. If the system call is a blocking system call, then the core operating system assigns a worker task (which is a core operating system task executing in a partition as illustrated in FIGS. 3 and 8) to complete the request, and returns control to the partition operating system. The partition operating system then pends the requesting task, and schedules the next highest priority task that is ready to run. When the assigned core operating system task completes the system call, a system-call-complete pseudo interrupt is issued by the core operating system to the partition operating system. After receiving the system-call-complete, the partition operating system places the task in the “ready” queue (i.e., it makes the task ready to run, but does not deschedule the current task). Alternatively, the system could be designed such that, upon receiving the system call complete, the partition operating system pends the currently executing task and schedules the requesting task.

An exemplary implementation of this functionality is described in more detail in related U.S. application Ser. No. 10/273,333 referenced above.

FIG. 8 shows an exemplary system architecture of the target system according to an embodiment of the present invention. The target component 12 of the logic analyzer 82 resides in the core OS 112 and maintains the event log(s) 80 in the memory of the core OS 112. Each partition operating system is preferably implemented as an executable entity on top of the core operating system so the partition operating system operation does not usually depend on the details of the core operating system. Rather, the partition operating system simply needs a specific set of services to be provided by the core operating system, particularly services related to the underlying system hardware (e.g., I/O operations, interrupts, exceptions). To provide this level of functionality, an abstraction layer 1070 is preferably interposed between the partition operating systems and the core operating system.

As shown in this example, three partitions 150 are established in system 100, each containing a partition OS 160 and a user application 170. Each user application 170 includes one or more user tasks 175 which may execute within their respective partition 150. Each partition OS 160 provides a partition OS API to allow user applications 170 to access the services provided by partition OS 160. Each partition OS 160 may also include a number of system tasks 165 instantiated to perform system services requested by user application 170. Partition OS 160 includes a scheduler 162 to control the scheduling of tasks executable within the partition 150 (i.e., user tasks 175 and system tasks 165), and a number of ready queues 167 and pending queues 166 to implement task ordering and blocking.

Abstraction layer 1070 provides a facility for partition OS's 160 to communicate with Core OS 112 (as will be further described below). Core OS 112 provides its own API, which is only accessible via abstraction layer 1070.

Among the facilities provided by core OS 112 are a task data structure 118, a scheduler 114, a number of ready queues 116 and pending queues 120, and various interrupt and exception handling routines 122. Task data structure 118 includes entries for each core OS task which exists in system 100. Each partition 150 also has an entry in the task data structure 118. Although not a core OS task, each partition 150 has an entry in the task data structure 118, as partitions are schedulable entities, and the task data structure 118 provides a convenient location for storing parameters associated with the partition 150. The core OS scheduler 114 can determine whether an entry in the task data structure 118 corresponds to a partition through the use of an indicator in the partition's entry in the task data structure.

Core OS 112 also includes certain pre-instantiated tasks 124—referred to as “worker tasks” (item 306.1 in FIG. 3). Each partition 150 is preferably associated with at least one worker task 124. Worker tasks are tracked by a worker task data structure 126 (preferably maintained for each partition as a linked list). As described further below, worker tasks 124 may be used by partitions to perform core OS services that are blocking, thus allowing other ready tasks in the partition to execute.

Core OS 112 also includes a number of “event queues” 130. Each partition has a corresponding event queue 130 located in core OS 112. As further described below, data related to events (e.g., hardware interrupts, exceptions, clock ticks) pertaining to a partition are stored in the event queue for delivery to the partition via the “pseudo-interrupt” facility

Preferably, abstraction layer 1070 is a thin layer of code that abstracts the specifics of the underlying core operating system so allowing the partition operating systems to run. In order to provide sufficient separation among the core operating system and the various partitions, it is advantageous to limit the number, and nature, of communication between the core operating system and each partition operating system. This architecture allows the core operating system to be used with multiple types of partition operating systems (perhaps in the same overall system), and allows the partition operating system to run on more than one type of core operating system, with minimal changes. A particularly preferred embodiment of the abstraction layer will now be described, wherein the communication between the partition operating systems and the core operating system is limited to:

1. System Calls (from a partition operating system to the core operating system)

2. Pseudo-Interrupts (from the core operating system to a partition operating system) In this embodiment, abstraction layer functionality resides in both the core operating system and each partition operating system. Each half of the abstraction layer understands the requirements and data format expected by the other half.

System calls are initiated by the partition operating system to request the core operating system to perform a desired service. In this example, there is only one system call API defined by the abstraction layer, which can multiplex all service requests. The partition operating system can request a core operating system service by issuing the system call (e.g., vThreadsOsInvoke( ), for purposes of illustration). This system call causes the portion of the abstraction layer in the partition operating system to issue a system call proper (e.g., valOsInvoke( ), for purposes of illustration) to the portion of the abstraction layer in the core operating system. In the core operating system portion of the abstraction layer, the system call proper is converted into an appropriate core operating system API call which performs the desired service(s). Preferably, the set of system services (methods) that the partition operating system is allowed to request is limited.

Preferably, all service requests from the partition operating system are invoked via the single system call (vThreadsOSInvoke( )). Upon receiving the system function call, the partition operating system portion of the abstraction layer issues the system call proper (valOsInvoke( )) as described above. The arguments of valOsInvoke( ) specify the service requested along with any additional parameters. The core operating system portion of the abstraction layer performs parameter validation on all system call arguments before invoking core operating system API functions.

The actual invocation of core operating system services depends on the mechanism that is used by it (e.g. the Linkage Table method for VxWorks AE, or a UNIX-style system call invocation). Only the core operating system portion of the abstraction layer need know the details of how core operating system services are invoked.

An exemplary implementation of the abstraction layer functionality is described in more detail in related U.S. application Ser. No. 10/273,333 referenced above.

As noted above, pseudo-interrupts may be used, inter alia, to provide asynchronous event notification/information (including clock tick and service call complete events) to the partition operating system (as contrasted with a traditional hardware interrupt/exception). A preferred implementation of the pseudo interrupts will now be described in more detail. In accordance with this implementation, each partition has a corresponding event queue in the system protection domain. This event queue may, for example, be organized as an array of event structures. The core operating system follows a two-step process in delivering a pseudo-interrupt to a partition operating system: first, an event is placed in the queue, and then, a signal is sent to the receiving partition operating system. An exemplary set of events is as follows:

1. “Power Interruption”

2. “Synchronize”: used by the core operating system to detect whether the specified partition operating system is executing a critical code section, such that access of operating system data structure may produce inaccurate results. Useful for interactions with development tools

3. “System Clock Tick”: reports the occurrence of a “tick” of the system clock, allowing each partition operating system to receive synchronized time information.

4. “Port Receive Notification”: indicates that a message has been received at a destination buffer 303.

5. “Port Send Notification”: indicates that a message in a source buffer 302 has been sent (see FIG. 7, and accompanying discussion).

6. “System Call Complete”: reports the completion of a previously requested system call to the core operating system that was dispatched to a worker task.

It should be noted, however, that synchronous exceptions are not queued in this implementation. Rather, the core operating system re-vectors the program flow of the partition's code by directly changing the program counter (pc) to execute the partition's synchronous exception handler. An exemplary implementation of the pseudo interrupts are described in more detail in related U.S. application Ser. No. 10/273,333 referenced above.

As noted above, the target component 12 of the logic analyzer resides on the core OS. As the target component 12 runs, event information is stored with a time stamp in a log 80 maintained by the core OS 112. As described below, events which occur in one of the partition OS's are written to the log 80 in Core OS via a system call.

The log 80 is uploaded to the host periodically where a parser in the host reads the log 80. The log information is converted into a graphical display using the time stamp associated with each logged event. As described above with reference to FIG. 3, a graph is generated with the tasks listed vertically, and time represented on the horizontal axis. The tasks are grouped according to the partition to which they belong in an outline format. For example, tasks belonging to the core OS are displayed under a heading for the core OS. In the display of FIG. 3, the heading 306 corresponds to the core OS. The state of each task at each tick is plotted on a graph with a specific line pattern indicating the task state at the corresponding time on the graph. Specifically, a task in the Core OS is represented by a horizontal strip, which may contain representation of events and states, such as running, pending etc., as discussed previously.

Each partition (308, 310m 34) in the partition OS is also shown as a horizontal strip, but with a different icon. The tasks within a partition operating system (e.g. threads 311.1), if present in the logged data received from the target are also shown as a horizontal strip, containing events and states, if the data is emitted from the target. The horizontal axis represents increasing time.

The logs 80 can be created with a three stage process. The first stage is to configure the amount and types of data collected from the core and partition OSes. The data emitted by the core and partition OSes can be ‘tailored’ to meet the user requirements. This stage includes creating a list of partitions to be instrumented, and the addresses of relevant variables within each partition. The next stage is to create the configuration data for the core OS. This ensures that the correct event dictionary for the core OS is loaded by the host tool before the event data arrives.

The final stage, during which event data collection is enabled, may be implemented as follows. The core OS function wvEvtLogStart( ) is called, perhaps from the host, by a command entered into the target, or by a trigger. This enables event generation within the core OS, and then causes the variables within each partition OS to be accessed and set in such a way that the partition OS can emit events to the core OS. The function wvEvtLogStop( ) in the core OS performs the reverse function, by disabling logging within each partition OS and the core OS.

The log contains events generated by the Core OS and each partition OS, or namespace. The first events in the log are the configuration events for the Core OS portion of the log. Configuration data for each partition is emitted later, at the time when the first event from each partition is sent. This ensures that the correct dictionaries for the core and each partition are known before the event data is seen. When an event is emitted from a partition, a special event, NAMESPACE_SELECT, precedes it. This event contains an identifier for the partition emitting the event, which tells the host tool that a different dictionary is required. The first time a NAMESPACE_SELECT is sent, it is immediately followed by configuration data for the partition, and then any other data. The configuration data will include an identifier for the event dictionary to be used subsequently for the partition, and may also include names of tasks within the partition. Subsequent NAMESPACE_SELECT events are simply followed by the event data for the partition OS.

Preferably, each event is entered into the log with a corresponding time stamp indicating when the event occurred. Two types of time stamps are provided, sequential and system. A sequential time stamp is an increasing integer value assigned to events in the order they occur. This shows the order in which events occurred, but does not allow timing analysis. System time stamps are a system-provided high-resolution source that represents the time an event occurs relative to the start of log collection on the target.

The EVENT_LIBRARY_DESCRIPTOR event may include the library name or identity, its version, the first event used by the library and number of events used by the library, among other information. In this manner, the EVENT_LIBRARY_DESCRIPTOR event allows events for different partition OS implementations and versions to co-exist in the same log. Versioning of instrumented libraries is also made possible. Each instrumented library has an initialization function that will add its corresponding library to a list of library descriptors. The list of descriptors is accessed during creation of the log headers by the wvLogHeaderCreate( ) function to pass namespace information to the parser using the EVENT_LIBRARY_DESCRIPTOR event.

Some exemplary events in a log may include:

EVENT_NAMESPACE_EXIT—indicates the end of the currently-executing partition

EVENT_NAMESPACE_SELECT. This event indicates to the host that a different partition is active and that the parser should switch to a different set of event dictionaries (i.e., the event dictionaries for the new namespace (i.e., partition)) until another namespace change event is received. An exemplary format is:

| | |
|---|---|
| UINT16 | eventId |
| UINT32 | namespaceId |

EVENT_CONFIG—This event, described above, provides the partition ID for the core OS. and other configuration data.

NAMESPACE_IDENTIFY—This is similar to the EVENT_CONFIG event, but is used for partitions. This event describes the event dictionary required for a partition.

EVENT_LIBRARY_DESCRIPTOR—As noted above, this event describes the instrumentation libraries and versions in the core or specific partitions. An exemplary format is:

| | | |
|---|---|---|
| UINT16 | eventId | |
| UINT16 | ident | (library identification) |
| UINT16 | version | (library version) |
| UINT16 | firstEvent | (first event in range used by library) |
| UINT16 | numEvents | (number of events used by the library) |

A number of logging functions are available in the core OS to create and maintain the logs, including the wvPartitionLogConditional ( ) function, which indicates to the logic analyzer the source of events to follow for the log. The source is initially set to core OS, but the function changes it to the currently executing partition. An exemplary implementation of the wvPartitionLogConditional ( ) function is shown in Table 1.

TABLE 1
wvPartitionLogConditional( ) function.

LOCAL currentLoggingPartition = <CoreOS Partition ID>;
wvPartitionLogConditional (PART_ID arcPartition)

{
if (srcPartition != currentLoggingPartition)

{
namespaceChangeEventEmit (SrcPartition);
currentLoggingPartition = srcPartition;
}

}

The function checks whether there is a change in the source partition (i.e., the currently logging partition) and if there is, emits a namespace change event to the log and sets the current logging partition equal to the source partition. Preferably, the Protection Domain id is used as the partition identifier (namespace id) for this function. We note that this function reduces the number of times the PARTITION_SWITCH event is recorded in the log. Each event takes a finite amount of space, so it is better to infer the active partition if possible, rather than rely on explicit PARTITION_SWITCH events for each event.

Since the first event in the log is usually a CONFIG event, the call to wvPartitionLogConditional( ) need not be made for the first event recorded from the core OS. The partition identifier is recorded in the CONFIG event for the core OS.

When an event occurs in a partition, a logging function in the partition makes a system call to the core OS. The events are passed from the partition to the core in a buffer. Preferably, the buffer is a fixed-size buffer. A call is made to the wvPartitionLogConditional ( ) function to record the source partition of the event. The buffer is then copied to the event log maintained in the core OS.

In an alternative embodiment, wvPartitionLogConditional( ) is not implemented, and when any event is received from the partition, the Core logging function always prepends

EVENT_NAMESPACE_SELECT

Partition Id

and appends

EVENT_NAMESPACE_EXIT.

This allows the parser to select correct dictionaries for each partition, and also to track changes in the running thread in each partition.

The buffer in the partition may or may not include a timestamp. In some implementations, the partition OS would not have access to the hardware providing the timestamp data, and therefore, the partition buffer would not include a timestamp. In this situation, if the event requires a timestamp, the timestamp will be written into the log by the core logging function. A flag is passed in the buffer to indicate whether the core logging function is required to add the timestamp.

If required, the timestamp is written by the core logging function at the same offset within any event in which the timestamp is written. In this embodiment, the timestamp should be taken as late as possible, and interrupts should be disabled from the time that the timestamp is taken, until the event is written into the log.

If the event log in the core OS memory space is full, then the core OS function wvEvtLogStop( ), which prevents further logging, is called, and ERROR is returned to the logging function in the partition OS. This disables the logging functions in the partition OS. Thus when the log is full, as each partition OS makes a call to record an event, that partition OS has its logging disabled.

A process for creating and maintaining the system log will now be described. Before beginning log creation, the instrumentation level for the core OS and each partition OS is set. In this manner, the volume and types of events which will be logged can be independently set within each partition. In any event, the first step in creating the log is to create the log header in the core OS. This includes recording the names of core OS tasks, and the partitionId of the core OS partition.

Thereafter, wvEvtLogStart( ) (or an equivalent function) is called, which enables logging in the Core OS. Then, for each partition OS in the system, event collection is enabled as determined by the instrumentation configuration detailed above. This can be implemented with a core OS function which writes configuration data into each partition OS. As each partition OS is enabled, it will start emitting events to the Core OS, which, in turn, stores them in the log.

While the core OS is executing, events from the core OS are stored in the log by the core OS. However, as determined by the core OS scheduler, execution may pass to a partition OS as described above. As the partition OS encounters instrumentation points (e.g., events which are to be logged as defined by the instrumentation level of the partition OS), these events must be recorded into the event log. However, instead of writing to the log directly, a function in the partition OS makes a call to a core OS function.

This function in the partition also ensures that the names of the threads (tasks) in the partition are known to the host tool. In order to accomplish this, the first time an instrumented point (event) is encountered, the function lists all the thread names, and the events representing them (EVENT_TASKNAME), and passes this information to the core OS to be stored in the log in the core OS. The partition OS also records the Partition OS version which it is running by sending the EVENT_NAMESPACE_IDENTIFY event to the core OS for storage in the log. In this regard, a flag is cleared so that this version data, and the task names, are only recorded once. In this manner, for each event recorded, it is possible to determine the source partition, and the OS version in the partition.

When each event is passed into the core, the core OS logging function prepends EVENT_NAMESPACE_SELECT Partition Id, and appends EVENT_NAMESPACE_EXIT in the manner described above. Events which the partition may send include APEX events, POSIX events, and events from the partition OS scheduler. A timestamp may be added to the events at this point by the core OS. Event collection proceeds in the above manner until the log is full, or collection is stopped by the user.

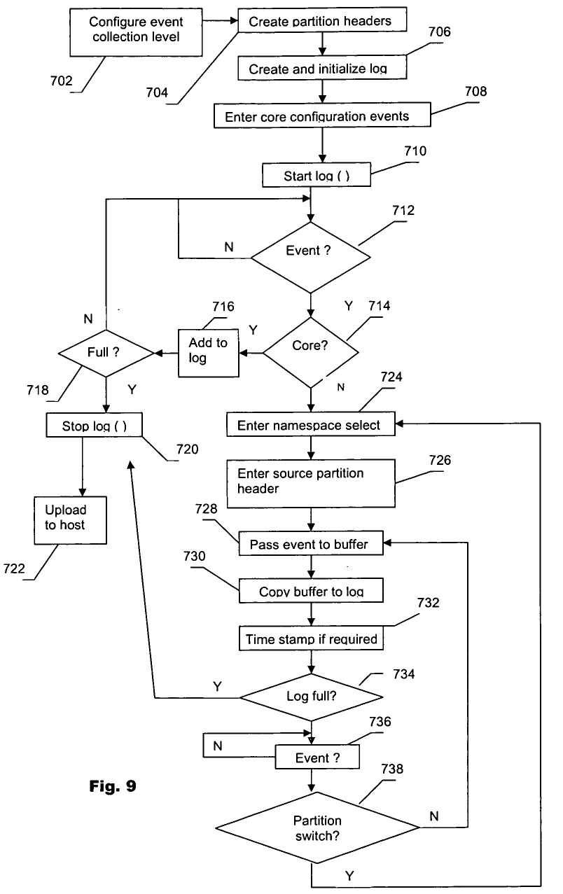

An alternative process for creating and maintaining the system log is provided in FIG. 9. The creation of the log is started by the host configuring the event collection level (step 702). Partition headers are created for each partition (step 704), and an empty log is created and initialized (step 706). The first events entered into the log are the configuration events for the core OS (step 708) which includes the core OS header with the partition ID for the core and the event libraries used by the core. At this point, data collection may begin and a start_log( ) function is called (step 710). The function maybe the wvEvtLogStart( ) function discussed previously or any other function to start logging events. The system waits for an event to occur at each tick and when it does (step 712), the partition ID associated with the event, indicating the source partition, is read to determine if the event originates from the core (step 714). If it does, the event is added to the log (step 716) since the configuration events for the core were already entered (step 708). After writing to the log, it is checked for remaining capacity (step 718) and if there is none left, a stop log function is called (step 720) and the log is uploaded to the host (step722). Again, the stop log function may be the wvEvtLogStop( ) function previously discussed. If the log is not yet full (step 718), the system waits for the next event (step 712).

If the event is not from the core (step 714) it would indicate that a partition switch has occurred. Therefore, a namespace_select event is entered into the log (step 724) to indicate to the parser that a partition switch is about to occur. The namespace_select event is followed by the header for the new source partition (step 726) which contains the partition ID and the event dictionaries used by the partition. The event is written to a buffer (step 728) and then a system call is made by the source partition to the core OS to copy the data in the buffer into the log (step 730). If the buffer did not already include a timestamp, then after entering the event to the log, the timestamp is taken and written to the log as well (step 732).

After writing to the log, its capacity is checked (step 734). If the log is full, logging is stopped (step 720), and the log is uploaded to the host (step 722). If the log is not full (step 734), the system waits for the next event (step 736) and determines if a partition switch has occurred (step 738). If it has not, steps 728-734 are repeated to enter the event into the log. This process repeats until a partition switch does occur (step 738), in which case, a namespace_select event is entered (step 724) and steps 728-734 are repeated for the events originating from the new partition until another partition switch occurs, or the log is full. Once the log is full (step 734) the stop log function is called (step 720) and the log is uploaded to the host (step 722).

An exemplary host-side process for processing the uploaded logs will now be described. When loading the collected log, the Host tool needs certain information. For example, it needs the OS version of the Core OS, which is encoded in the EVENT_CONFIG event. This is the first event in the log. Other information follows EVENT_CONFIG event in the log, describing the type of timestamp information supplied, and also the Partition Id of the core OS. This information allows the host to load a description of the event types implemented in the core OS. Once the event types are loaded, the host can decode any events generated by the core OS.

Events from the partitions OSes will be preceded by the EVENT_NAMESPACE_SELECT event, and the first event from a partition should be an EVENT_NAMESPACE_IDENTIFY. This allows the host to associate an event dictionary with the partition, and consequently allow it to decode the events from the partition. Once this information has been determined for each partition, the host can decode any event from the core OS or any partition OS. Each time an EVENT_NAMESPACE_SELECT event is received, an appropriate dictionary is used, and when an EVENT_NAMESPACE_EXIT is encountered, the dictionary from the Core OS is used. When an event has been decoded, it can be added to the internal representation of the execution of the target. This could be displayed as a graph as in FIG. 3, or any other type of representation. Internally, the representation could be a series of lists, where each list represents a VxWorks task or thread, and events are associated with a particular time in each task or thread.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A method for displaying analysis data of a partitioned OS comprising the steps of:
reading event information from an event log;
determining a partition ID, task name and task state corresponding to the event information;
displaying on a graphical display, a visual representation of the partition ID, task name and task state at a specific, corresponding time on a time graph, the visual representation positioned to correlate with the partition ID.

2. The method of claim 1, wherein,
prior to said reading step, the method comprises the steps of
implementing a core operating system;
providing a system space having a number of memory locations;
operating the core operating system to create a number of protection domains to partition the system space;
implementing a partition operating system and a partition user application pair in each partition, whereby the partition operating system, partition user application pairs of the partitions are spatially partitioned from each other;
operating each partition operating system of each pair to provide resource allocation services to the respective partition user application within the partition; and
wherein, the partition ID includes a plurality of partition ID's, the core operating system and each partition is associated with a corresponding one of the partition ID's.

3. The method of claim 1 wherein the determining step further comprises:
loading an event dictionary corresponding to the partition ID, the event dictionary including event definitions for events corresponding to the partition ID;
determining the task name and task state from the event definitions.

4. A method for monitoring the execution of a plurality of tasks in the memory of a target computer comprising the steps of:
coupling the target computer to a host program with a communications link;
running a plurality of tasks on the target computer;
producing event data, the event data including a partition ID;
entering the event data into a log with a time stamp;
uploading the log to the host;
parsing the log to retrieve the event data;
accessing the partition ID;
loading an event dictionary corresponding to the partition ID;
determining a task name and task state from the event dictionary;
displaying the task name on a first axis with the partition ID;
displaying time progression on a second axis;
displaying a graphical icon representative of the task state at a time on the second axis corresponding to the time stamp.

5. The method of claim 4 wherein the producing events step further comprises switching to a second partition and the entering step further comprises entering an indication of the switch to a second partition, and configuration information for the second partition.

6. The method of claim 5 wherein the configuration information further comprises the second partition ID, and the second partition event dictionary.

7. The method of claim 4, wherein said running step comprises the steps of
implementing a core operating system;
providing a system space having a number of memory locations;
operating the core operating system to create a number of protection domains to partition the system space;
implementing a partition operating system and a partition user application pair in each partition, whereby the partition operating system, partition user application pairs of the partitions are spatially partitioned from each other;
operating each partition operating system of each pair to provide resource allocation services to the respective partition user application within the partition; and
wherein, the partition ID includes a plurality of partition ID's, and the core operating system and each partition is associated with a corresponding one of the partition D's.

8. A method for monitoring the execution of a plurality of tasks in the memory of a target computer, the method comprising the steps of:
coupling the target computer to a host program with a communications link;
running a plurality of tasks on the target computer, producing a plurality of contexts;
logging event data representing a plurality of events in the plurality of contexts, the event data including an event identifier, a partition identifier, a time stamp, and an array of parameters in a predetermined order;
uploading the event data from the target computer memory to the host program;
reconstructing a status of the tasks from the event data;
storing reconstructed data in the host program; and
displaying the status from the reconstructed data for a period of time for a plurality of the tasks with the same partition identifier on a display.

9. The method of claim 8, wherein said running step comprises the steps of
implementing a core operating system;
providing a system space having a number of memory locations;
operating the core operating system to create a number of protection domains to partition the system space;
implementing a partition operating system and a partition user application pair in each partition, whereby the partition operating system, partition user application pairs of the partitions are spatially partitioned from each other;
operating each partition operating system of each pair to provide resource allocation services to the respective partition user application within the partition; and
wherein, the partition ID includes a plurality of partition ID's, and the core operating system and each partition is associated with a corresponding one of the partition ID's.
